(19) United States
(12) Patent Application Publication
(10) Pub. No.: US 2008/0074264 A1
(43) Pub. Date: Mar. 27, 2008

(54) PRODUCT INFORMATION ASSOCIATED WITH CUSTOMER LOCATION

(75) Inventors: Bruce Sharpe, Aurora, CO (US); James Horgan, Highlands Ranch, CO (US); Steven Chalmers, Parker, CO (US); Michael Miller, Denver, CO (US)

Correspondence Address: MERCHANT & GOULD PC, P.O. BOX 2903, MINNEAPOLIS, MN, 55402-0903, US

(73) Assignee: TeleTech Holdings, Inc., Englewood, CO (US)

(21) Appl. No.: 11/533,231

(22) Filed: Sep. 19, 2006

(51) Int. Cl. G08B 13/14; G06F 17/00; G08B 1/08

(52) U.S. Cl. 340/572.1; 235/375; 340/539.13

(57) ABSTRACT

Exemplary embodiments of the present invention comprise systems and method for providing information to an in-store customer. An embodiment of the system includes several radio frequency identification (RFID) tags placed in predetermined areas within the shopping area. A mobile device, carried by the customer, receives signals from the RFID tags. The signals are used to determine the location of the customer within the store. The determined location is used by an information server to return location-specific information and advertising to the mobile device. The mobile device displays the location-specific information and advertising to the customer.

### BACKGROUND

Big box stores, such as “BEST BUY™” or “SEARS®,” often lack the highly-trained personnel that are required to help every customer in the store. Thus, customers are often unable to obtain information they may need to make a purchasing decision. The customers can become frustrated and leave the store without purchasing. These situations mean lost revenue for the stores.

In addition, the stores often advertise to in-store customers in a general manner, such as by hanging banners or placing small sale displays on shelves in the store. Advertising is not focused on certain customers or on customers seeking certain products. The lack of directed advertising fails to motivate buyers in their shopping decisions. Again, customers often leave without purchasing, and the stores lose possible revenue.

### SUMMARY

Embodiments of the present invention relate to systems and methods for tracking a customer within a shopping area and, using the tracking information, providing location-specific information and advertising.

In an exemplary embodiment of the present invention, a system for providing information to a customer includes several radio frequency identification (RFID) tags placed in predetermined areas within the shopping area. A mobile device, carried by the customer, receives signals from the RFID tags. The signals are used to determine the location of the customer within the store. In one embodiment, the mobile device sends the determined location to an information server, which returns location-specific information and advertising to the mobile device. The mobile device displays the returned information to the customer.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWING

FIG. 1 is a simplified system diagram representing an embodiment of a store location and information system.

FIG. 2 is a graphical user interface view of an embodiment of a display for a mobile device providing information associated with the location of a customer in a store.

FIG. 3 is another simplified system diagram representing an embodiment of a store location and information system having nested areas of interest.

FIG. 4 is another simplified system diagram representing an embodiment of the communications between a mobile device and an information server

FIG. 5 is a block diagram representing an embodiment of an information server.

FIG. 6 is a block diagram representing an embodiment of a mobile device.

FIG. 7 is another simplified system diagram representing an embodiment of a method for determining a location of a mobile device in a store.

FIG. 8 is a flow diagram representing a method for locating a customer in a store and providing, to the customer, information associated with the location.

FIG. 9 is a block diagram representing an embodiment of a computing environment and an embodiment of a computer system, the computer system operable to function as an information server or a mobile device.

### DETAILED DESCRIPTION

Embodiments of the present invention will be more fully described with reference to the accompanying drawings, in which only some of the possible embodiments are shown. Other embodiments may, however, have many different forms and the present invention should not be construed as limited to the embodiments set forth herein. Rather, the embodiments described herein are provided so that the disclosure will be thorough and complete and will fully convey the scope of the invention to those skilled in the art. Throughout the several drawings, like reference numerals designate like items.

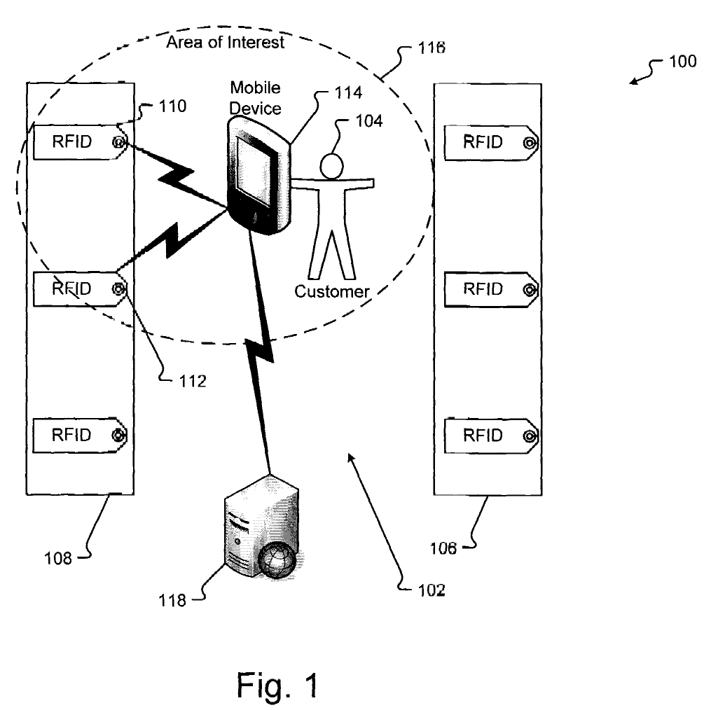

An embodiment of a store location and information system 100 is shown in FIG. 1. The store contains one or more display areas, such as aisle 102, which are defined by one or more product displays 106 and 108. The product displays 106 and 108 have affixed to a shelf or other surface one or more radio frequency identification (RFID) tags, such as RFID tags 110 and 112. In embodiments, other technologies besides RFID tags are used to transmit location information. In one embodiment, the RFID tags are active RFID tags that transmit a signal using a connected power source. For example, the RFID tags may be cardTag active RFID tags available from ActiveWave of Boca Raton, Fla.

A customer 104 walks through the display area 102. The customer 104 carries a mobile device 114. Mobile devices 114 include, but are not limited to, laptop computers, personal digital assistants (PDAs), cellular phones, or tablet computers. The mobile device 114 includes an RFID tag reader in electrical communication with the RFID tags. When the mobile device is within range, the RFID tag reader receives signals from one or more RFID tags 110 and 112. The position of the mobile device 114, and thusly, the customer 104, is determined. In embodiments, the customer 104 is determined to be in an area of interest 116. An area of interest, in embodiments, is a predetermined section of the store that encloses some product offering. Further, mobile device 114 periodically and repetitively receives the RFID signals to periodically determine the area of interest as the customer 104 moves through the store.

In embodiments, the mobile device 114 is in electrical communication with an information server 118, also referred to as an application device or application server, to receive information about products within the area of interest 116. For example, the information server 118 sends product specifications and information to inform the customer's buying decision. In other embodiments, the application server 118 streams one or more advertisements to the mobile device 114 that are related to the area of interest 116. For example, if the customer 104 is in digital cameras, the information server 118 sends a first advertisement for a “NIKON™” digital camera. After a period of time, the information server 118 sends a second sale offer for a Kodak digital camera. Thus, by determining the area of interest 116, the customer 104 can be offered specific and relevant information and advertising.

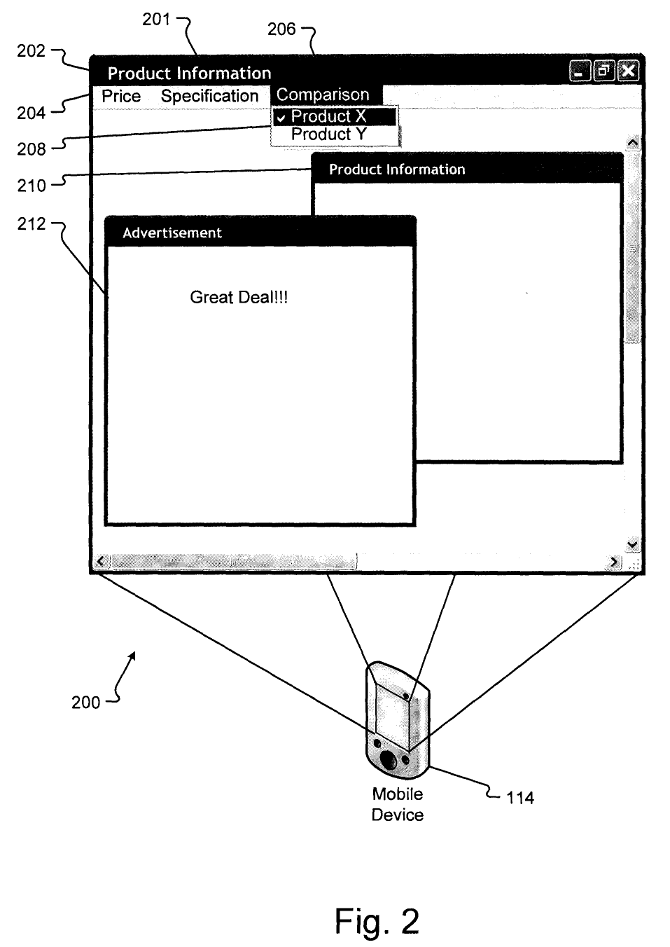

An example of a display 200 for the mobile device 114, described in conjunction with FIG. 1, is shown in FIG. 2. In an embodiment, the display 200 includes one or more windows, such as window 212 or 210. Window 201 includes, in embodiments, a title bar 202 and a menu bar 204 with selectable menus, such as the “Comparison” menu selection 206. By selecting the menu button 206, a drop-down menu 208 is displayed, and items within the menu 208 are available to be selected by a user.

Upon determining the area of interest for a customer, as explained in conjunction with FIG. 1, an information server 118 (FIG. 1), in embodiments, provides information or advertising specific to products in the area of interest. For example, the mobile device 114 displays an advertisement 212 that is associated with a product in the determined area of interest. In another embodiment, the menu selections in the drop-down menu 208 are specific to products within the area of interest. Selecting one of the menu selections in the drop-down menu 208 instructs the information server to provide product specific information in another window 210. Other information may be displayed on mobile device 114, and the type of information displayed is not limited to the embodiments described herein. The information provided may be any type of multimedia information, such as video, pictures, sound, information displays, etc. In one embodiment, the presentation of information on the mobile device 114 is coordinated with in-store events. For example, the customer receives information for a certain product while a spotlight in the store highlights the product of interest.

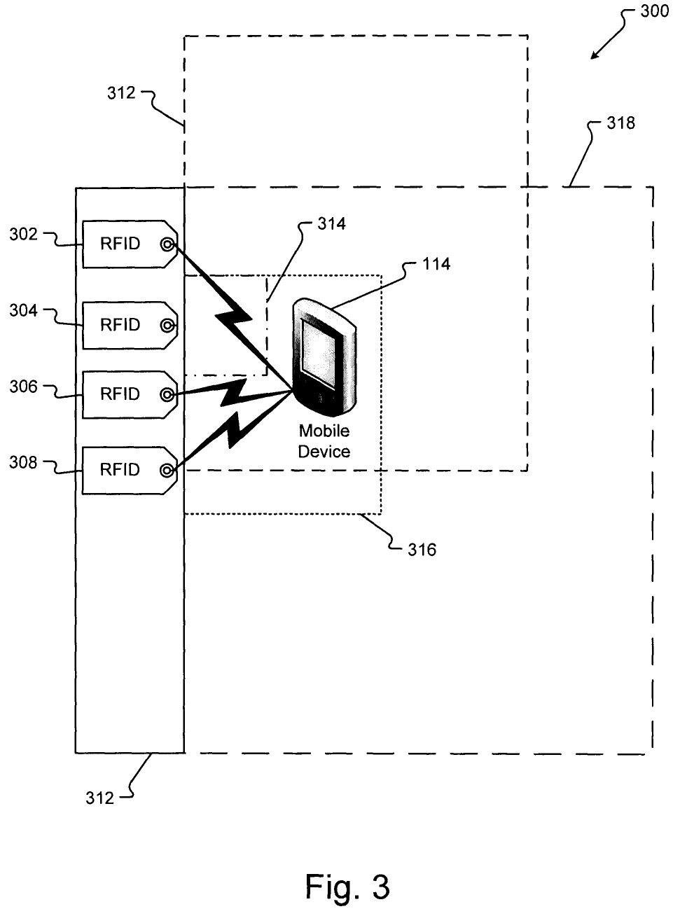

An embodiment of a store 300 having a plurality of nested areas of interest is shown in FIG. 3. In an embodiment, the active RFID tags 302, 304, 306, and 308 are affixed to a store shelf 310, and each RFID tag 302, 304, 306, or 308 have an adjustable attenuation, such that the range for broadcasting of the RFID signal can be manipulated. For example, RFID tag 302 has a range designated by box 312, RFID tag 304 has a range designated by box 314, RFID tag 306 has a range designated by box 316, and RFID tag 308 has a range designated by box 318. Each of the ranges is different as is shown by the different sizes for boxes 312, 314, 316, and 318.

The mobile device 114 inside the store 300 may receive one or more RFID signals but may not receive all the RFID signals. For example, the mobile device 114 receives RFID signals from RFID tags 302, 306, and 308. However, the mobile device 114 does not receive an RFID signal from RFID tag 304 because the mobile device 114 is not close enough to the RFID tag 304 to be within range of the signal broadcast by RFID tag 304.

In embodiments, the different ranges for the several RFID tags 302, 304, 306, and 308 create different areas of interest. For example, RFID tag 308 provides a signal that has a large range represented by box 318 and represents the “aisle” area of interest. In other words, if the mobile device 114 receives the signal from RFID tag 308, the mobile device 114 recognizes that it is in the “aisle” area of interest. Further, if the mobile device 114 receives the RFID signal from RFID tag 306, the mobile device 114 recognizes that it is in the “digital cameras” area of interest. However, mobile device 114 does not receive an RFID signal from RFID tag 304 and recognizes that it is not in the “Kodak” area of interest. By changing the attenuation of the RFID tags 302, 304, 306, and 308 several nested areas of interest are created. A mobile device 114 in any one of the nested areas of interest receives different information and advertising, for example, from an information server 118 (FIG. 1). In embodiments, the areas of interest are as large as the entire store or as small as a specific product within the store.

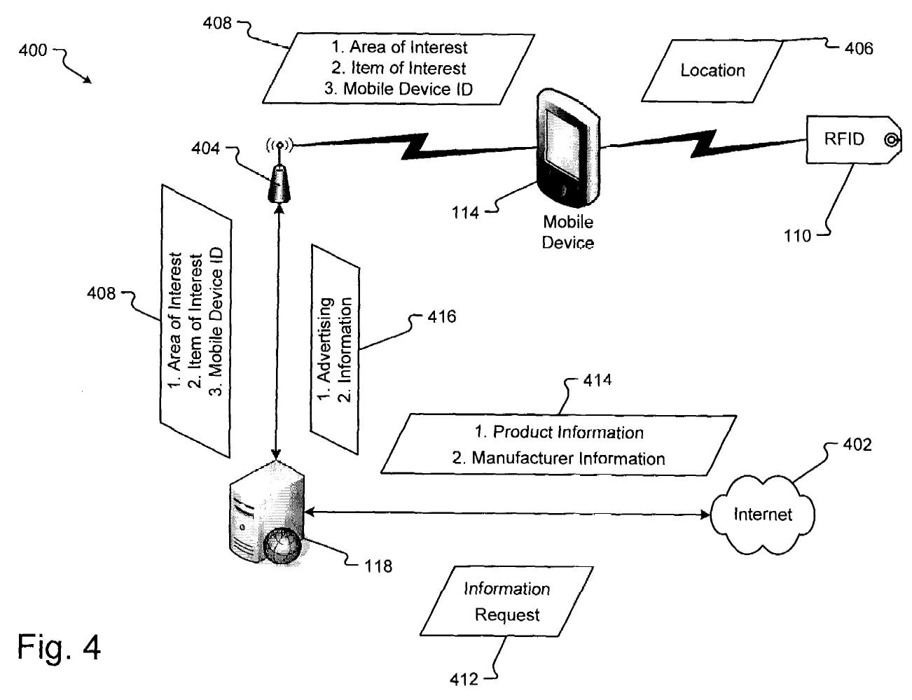

An embodiment of a communication process 400 for communicating an area of interest and receiving information and advertising related to the area of interest is shown in FIG. 4. In an embodiment, a mobile device 114 receives location information 406 from one or more RFID tags, such as RFID tag 110. The location information 406, in embodiments, may be a physical location, a designation of an area of interest, such as “aisle 2,” “digital cameras,” or “Kodak digital cameras,” or other information that may be used to determine in which area of interest the mobile device 114 is located.

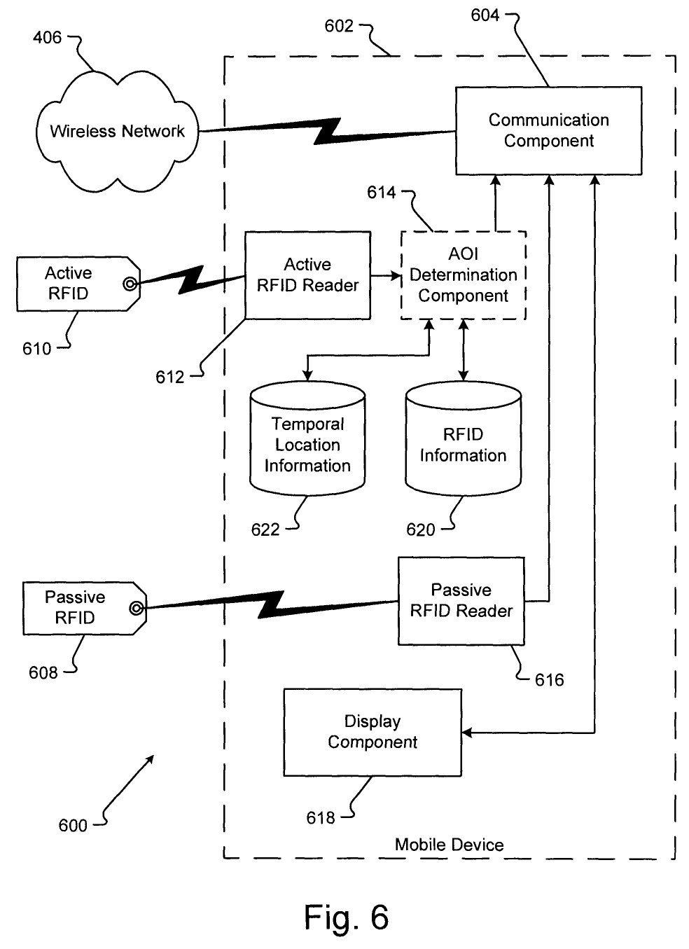

In embodiments, the mobile device 114 determines the area of interest for which it is located. The mobile device 114 forms a first message packet 408 to be sent to an information server 118. The first message packet 408, in one embodiment, includes, but is not limited to, the determined area of interest and mobile device identification, such as a mobile device-specific code. In a further embodiment, the first message packet 408 contains an identifier for an item of interest. The identifier may be a bar code, a model number, or the like. In one embodiment, the mobile device 114 includes a passive RFID tag reader, as explained in conjunction with FIG. 6, to read a passive RFID tag attached to a product. The information received from reading the passive RFID tag is inserted into the first message packet 408 as the item of interest.

The first message packet 408 is sent, in embodiments, over a wireless network 404 to the information server 118. In one embodiment, the information server 118 determines what information or advertising to send back to the mobile device 114. In other embodiments, the information server 118 retrieves information from one or more other sources, such as through an intranet or the Internet 402. For example, the information server 118 connects to a manufacturer's website or web portal through the Internet 402. In one embodiment, the information server 118 sends an information request 412 to the remote source. The information server 118 receives an information packet 414 containing various information that, in one embodiment, includes, but is not limited to, product information and manufacturer information.

In embodiments, the information server 118 compiles the information requested, such as information associated with an item of interest, or the information related to the area of interest. The information server 118 forms a second communication packet 416 to send back to the mobile device 114. In embodiments, the second communication packet 416 includes, but is not limited to, advertising and information. The information server 118 sends the second communication packet 416 over the wireless network 404 to the mobile device 114. Upon receiving the second communication packet 416, the mobile device 114 displays the information or advertising.

The process of determining the area of interest and sending information associated with the area of interest occurs, in embodiments, periodically. For example, every 30 seconds the area of interest is determined, and, if it is different than the previously determined area of interest, new information is sent to the mobile device. As such, the customer's movements are tracked and information or advertising appropriate to the customer's changing position is consistently displayed on the mobile device 114.

In an alternative embodiment, the mobile device 114 determines that the customer has entered a new area of interest. The mobile device 114 sends an extensible Markup Language (XML) Remote Procedure Call (RPC) to the information server 118 indicating that a new zone has been entered. The mobile device 114 sends the area of interest to the information server 118. A rules engine in the information server 118 determines which subscribers, software components which register with the rules engine to be alerted of certain events, need to know the occurrence of a new area of interest event. The information server 118 publishes the new area of interest event into a queue and alerts the pertinent subscribers that the event is published in the queue. An advertising dispatch listens to the queue and gets the message. The advertising dispatch correlates the new area of interest with associated advertising information. The required advertising is time stamped and is placed in a kiosk queue. The kiosk is a software component that interfaces with the one or more mobile devices 114. Another RPC call from the advertising dispatch alerts a kiosk of the posting of advertising for the mobile device 114. The mobile device 114 asynchronously listens to the kiosk queue and sends a request for the advertising. The kiosk processes the request and sends, to the mobile device 114, a Uniform Resource Locator (URL) for a location to retrieve the advertising, the time for how long the advertising should be displayed, and an indication of whether the advertising should expire when the mobile device 114 leaves the area of interest. A web browser control on the mobile device 114 accesses the URL and downloads the advertising content for display in a web browser on the mobile device 114. Other information may be retrieved in a similar manner. In other embodiments, the information is sent directly to the mobile device 114 without the transmission of a URL depending on the bit size of the information to be sent to the mobile device 114. This embodiment of the process for retrieving information provides a method where the network traffic is minimized.

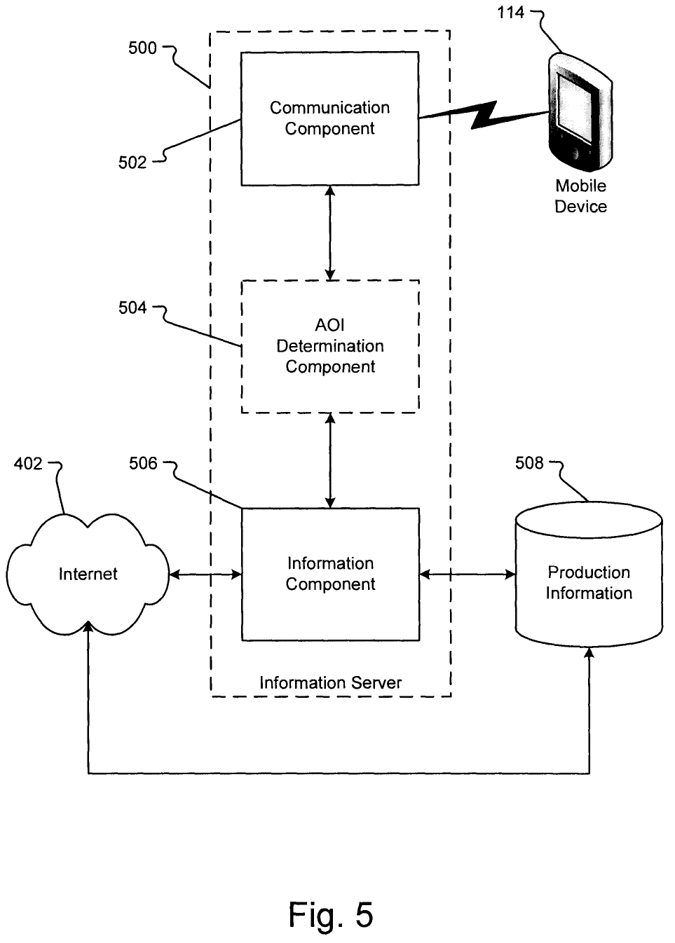

An embodiment of an information server 500, such as information server 118 described in conjunction with FIG. 1, is shown in FIG. 5. The information server 500, in embodiments, includes, but is not limited to, a communications component 502 and an information component 506. In some embodiments, the information server 500 includes an AOI determination component 504. The communications component 502 communicates with one or more mobile devices 114. The communications component 502, in embodiments, receives location information, such as an area of interest determined by the mobile device 114 or other information that can be used to determine the area of interest. In addition, the communications component 502, in embodiments, sends advertising and other information related to the area of interest to the one or more mobile devices 114.

The information component 506 associates the area of interest to advertising or information. In one embodiment, the information component 506 accesses a product information database 508. The product information database 508, in embodiments, includes, but is not limited to, information about manufacturers, warranty information, advertising, product information, third-party product information, and pricing information. In one embodiment, the product information database is local to the information server 500, either as an integral part of the information server 500 or as a separate system locally accessed. The product information database 508, in other embodiments, may be a remote database accessed over a network, such as the Internet 402. In other embodiments, the information component 506 accesses information through contacting manufacturers or other information sources over a network, such as the Internet 402.

In embodiments, the information component 506 records which areas of interest the customer visited. A visit to a store may be referred to as a single session for the customer. During a session, the customer may visit one or more areas of interest. Each area of interest visited is recorded and stored for analysis or for later use. In one embodiment, the information sent to the mobile device 114 for the customer is modified based on the stored information for the customer. For example, if a certain type of advertisement enticed that customer to buy a product during a previous session, the same type of advertising is sent to the customer during the current session. In addition, all sessions for all customers, in embodiments, is stored and analyzed to determine which information and advertising were most effective.

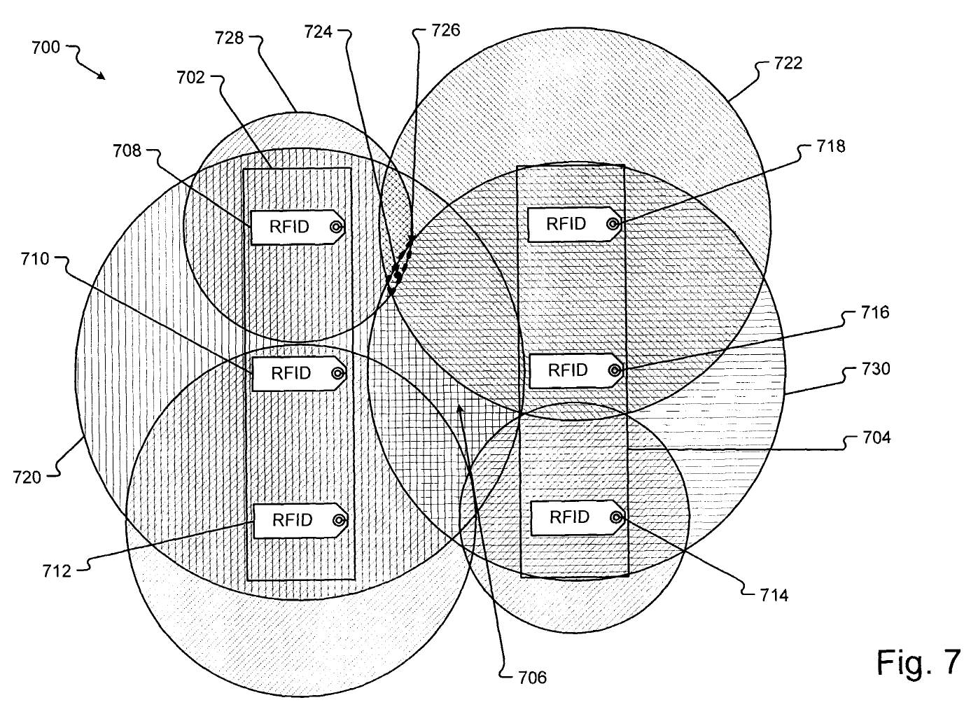

In embodiments, the information server 500 also includes an AOI determination component 504. For example, the mobile device 114 sends location information to the information server 500. The location information may include, but is not limited to, the RFID tag signals received, information from the RFID tags, or a calculated coordinate for the location of the mobile device 114. The location information is received by the communication component 502 and forwarded to the AOI determination component 504. Using the location information, the AOI determination component 504 determines the area of interest for the mobile device 114. Methods for how the AOI determination component 504 determines the area of interest are described in conjunction with FIGS. 6 and 7. The area of interest is then forwarded to the information component 506 to collect information associated with the determined area of interest.

The information server 500, in embodiments, pushes three types of information content to the mobile device 114, automatically-induced content, self-induced content, and agent-induced content. Automatically-induced content is information pushed to the mobile device 114 in response to a location being determined as explained above. Self-induced content is information about a product that is pushed to a mobile device 114 in response to a passive RFID tag being read, as explained in conjunction with FIGS. 4 and 6. Finally, agent-induced content is information pushed to the mobile device 114 from an agent over the internet 402. In embodiments, the presence and location of a customer is sent to an agent in a remote location. The agent pushes information to the information server 500 to be sent to the mobile device 114. An agent, in embodiments, is a customer service representative with special knowledge that can provide information or advertising specific to a product or specific to a customer.

An embodiment of a mobile device 602, such as mobile device 114 described in conjunction with FIG. 1, is shown in FIG. 6. The mobile device 602, in embodiments, includes, but is not limited to, an AOI determination component 614, a communication component 604, and a display component 618. In further embodiments, the mobile device 602 includes a passive RFID tag reader 616 and an active RFID tag reader 612. The active RFID tag reader 612, in embodiments, also represents two or more active RFID readers that receive signals having two or more different frequencies. In one embodiment, the mobile device 602 does not include the AOI determination component 614 but allows an information server, such as information server 500 (FIG. 5), to determine the area of interest.

In embodiments, the active RFID tag reader 612 receives signals from one or more active RFID tags 610. An example of an active RFID tag reader 612 is the Savi Mobile Reader SMR-630 from Savi Technology, Inc. of Sunnyvale Calif. The active RFID reader 612 converts the signal and extracts the useful information from the signal and sends the signal information to the AOI determination component 614, or alternatively, to the communication component 604 to be forwarded to an information server.

The AOI determination component 614, in embodiments, determines an area of interest from the location information. In one embodiment, each active RFID tag 610 provides simply an area of interest designator possibly including, but not limited to, “aisle,” “product section,” “product category,” “manufacturer,” and/or “product.” Each active RFID signal may provide one or more of the area of interest designators. For example, if the store has nested areas of interest, as explained in conjunction with FIG. 3, a first active RFID tag may only designate an “aisle” area of interest, but a second active RFID tag may designate an “aisle” area of interest, such as aisle 4, a “product category” area of interest, such as cameras, a “product section” area of interest, such as digital cameras, and a “manufacturer” area of interest, such as Kodak digital cameras. By receiving a plurality of signals, the AOI determination component 614 determines the most likely area of interest.

As an example, in one embodiment, the AOI determination component 614 receives 10 active RFID signals with location information, as represented by the following table, which will be used in the subsequent explanation:

| | Location Information | | | | |
|---|---|---|---|---|---|
| RFID | | Product | | | |
| Tag ID | Aisle | section | Product category | Manufacturer | Product |
| 1 | 4 | Cameras | Digital Cameras | Kodak | Kodak Model 12 |
| 2 | 5 | | | | |
| 3 | 4 | Televisions | Plasma Televisions | | |
| 4 | 4 | Cameras | Film Cameras | | |
| 5 | 4 | Cameras | Digital Cameras | Kodak | Kodak Model 16 |
| 6 | 4 | Cameras | Digital Cameras | Kodak | |
| 7 | 6 | | | | |
| 8 | 4 | Televisions | | | |
| 9 | 4 | Cameras | Digital Cameras | Nikon | |
| 10 | 4 | Cameras | | | |

The above table represents RFID signals received from 10 RFID tags having identification numbers one through ten. The location information represents a series of nested areas of interest having different levels. For example, the “Aisle” area of interest is a top level. The “Product” areas of interest are nested within the “Aisle” areas of interest and are on a lower level of areas of interest. For example, the aisle 4 area of interest has two lower lever areas of interest within it, “Cameras” and “Televisions.” The other location information, “Product Category,” Manufacturer” and “Product” represent successively nested and lower level areas of interest.

To determine the area of interest, the AOI determination component 614 determines the most likely area of interest. In one embodiment, the AOI determination component 614 completes some basic statistical analysis of the location information. In one embodiment, the AOI determination component 614 first determines the highest level area of interest and then determines each consecutively lower level area of interest if possible. For example, of the 10 active RFID signals in the above table, eight of the signals are for aisle 4. Then, in embodiments, the AOI determination component 614 calculates a ratio, shown as a percentage. The ratio is calculated by taking summing all instances that a first area of interest was designated at a first level of area of interest and dividing by the total sum off all designations of areas of interest in the first level of area of interest, e.g., 8 signals designating “aisle 4” divided by 10 total signals equals a 60% ratio. In other words, the AOI determination component 614 is 60% certain that the mobile device 602 is in aisle 4. The AOI determination component 614 may then ignore all signals not designating aisle 4. For the remaining eight signals, six signals have a “product section” designation of “cameras.” Thus, the AOI determination component is 75% certain that the mobile device is within the cameras section of aisle 4. Likewise, the AOI determination component 614 determines that it is 67% certain the mobile device 602 is in “digital cameras,” 75% certain the mobile device 602 is in the “Kodak” section of digital cameras, and that it is as likely the customer is looking at “Kodak Model 12” as “Kodak Model 16.”

In one embodiment, the AOI determination component 614 compares the ratio to a threshold, such as 50%. For example, the AOI determination component 614 designates the area of interest with the ratio above 50% as the area of interest for the mobile device 602 for that level of area of interest. In an alternative embodiment, the AOI determination component 614 compares the ratios for a first area of interest to a second area of interest. For example, a first area of interest has a ratio of 45%, and a second area of interest has a ratio of 33%. By comparing the ratios, the AOI determination component 614 determines that the first area of interest is more likely than the second area of interest.

The AOI determination component 614, in embodiments, provides the communication component 604 an area of interest determination of “Kodak digital cameras” and, possibly, provides information that the mobile device 602 could receive information about both “Kodak Model 12” and Kodak Model 16.” In some embodiments, if a lower level area of interest cannot be determined, an advertisement or information for the higher level area of interest is sent.

In another embodiment, the active RFID tags 610 only provide the lowest level area of interest for which they designate. In other words, the signals from the ten active RFID tags described above would provide RFID signals as shown in the table below:

| | Location Information | | | | |
|---|---|---|---|---|---|
| RFID | | Product | | | |
| Tag ID | Aisle | section | Product category | Manufacturer | Product |
| 1 | | | | | Kodak Model 12 |
| 2 | 5 | | | | |
| 3 | | | Plasma Televisions | | |
| 4 | | | Film Cameras | | |
| 5 | | | | | Kodak Model 16 |
| 6 | | | | Kodak | |
| 7 | 6 | | | | |
| 8 | | Televisions | | | |
| 9 | | | | Nikon | |
| 10 | | Cameras | | | |

The AOI determination component 614 then accesses an RFID Information datastore 620 in the mobile device 602 to determine the higher level areas of interest associated with the designated areas of interest shown in the table. As such, the same determinations can be made, but the RFID signals need not transmit the extra information.

In alternative embodiments, the RFID tag 610 transmits an RFID tag ID as shown in the table above. The AOI determination component 614 accesses an RFID information datastore 620 to correlate the RFID tag ID with the associated area of interest shown in the above table. In still other embodiments, the areas of interest visited by the customer are stored temporarily in a temporal location information datastore 622. As such, if the AOI determination component 614 finds that two or more areas of interest are likely for a customer, i.e., the ratio for a first area of interest equals the ratio for a second area of interest, the AOI determination component 614 accesses the temporal location information datastore 622 to determine what area of interests the customer has already visited. As such, if one of the areas of interest determined to be a likely area of interest has not been visited or designated previously, the AOI determination component 614 designates the unvisited area of interest to be the most likely area of interest for a current location. Other embodiments of methods for determining the area of interest are described in conjunction with FIG. 7.

The communications component 604 communicates with an information server, such as information server 500 (FIG. 5). The communications component 604, in embodiments, receives location information, such as an area of interest determined by the AOI determination component 614 or other information that can be used to determine the area of interest. In embodiments, the location information is sent to the information server over a wireless network 406. In addition, the communications component 502, in embodiments, receives advertising and other information related to the area of interest from the information server. The communications component 604 then sends the advertising and other information to the display component 618.

In embodiments, the display component 618 provides the advertising and other information to the customer in an easily understood format. For example, the advertising and other information are displayed in a graphical user interface, such as the display described in conjunction with FIG. 2. Further embodiments of the display component 618 allow for the customer to input requests into the display component 618. The requests are forwarded to the communication component 604 to be sent to the information server. For example, the customer requests a product comparison by selecting a menu item in the graphical user interface, as described in conjunction with FIG. 2.

The mobile device 602, in further embodiments, also includes a passive RFID tag reader 616 that reads signals from a passive RFID tag 608. An example of a passive RFID tag is the AD-420 RFID tag from Avery Dennison of Pasadena Calif., and an example of a passive RFID tag reader is the AWID MPR-3014 from Applied Wireless ID of Morgan Hill, Calif. Each product in the store may have a passive RFID tag affixed to the product. The customer reads the passive RFID tag 608 by enabling, such as through the graphical user interface or other input, the passive RFID tag reader 616. Upon receiving the passive RFID signal, the passive RFID reader 616 sends the product information to the communication component 604, which is sent to the information server as an item of interest information in a first communication packet 408 (FIG. 4). The information server can then respond by providing information specific to the product having the particular passive RFID tag 608.

Another embodiment of a method for determining the area of interest is displayed in FIG. 7. A store 700 contains one or more product displays 702 and 704 that generally define an area 706 where a customer may travel. The product displays 702 and 704 have one or more active RFID tags 708, 710, 712, 714, 716, or 718. Each RFID tag 708, 710, 712, 714, 716, or 718 has a predetermined and adjustable attenuation or range for the RFID signal. For example, RFID tag 710 has a range defined by the circle 720, and RFID tag 718 has a range defined by circle 722. A mobile device, such as mobile device 114 (FIG. 1), may receive one or more of the RFID signals.

In an embodiment, each RFID signal includes a Cartesian coordinate or other coordinate location for the RFID tag and the range. The mobile device at a position 724 receives four RFID signals from RFID tags 708, 710, 716, and 718, as represented by the position 724 being enclosed in the range circles 728, 720, 730, and 722, for the four RFID tags. The mobile device can use the coordinate locations and the ranges to roughly triangulate the position of the mobile device and determine that, by the ranges and locations of the RFID tags 708, 710, 716, and 718 for which a RFID signal was received, the mobile device must have a position within the area defined by dotted line 726. The mobile device then accesses a datastore to determine which area of interest the area 726 is located. One skilled in the art will recognize other methods for determining the area of interest which are possible and included in the spirit and scope of the appended claims.

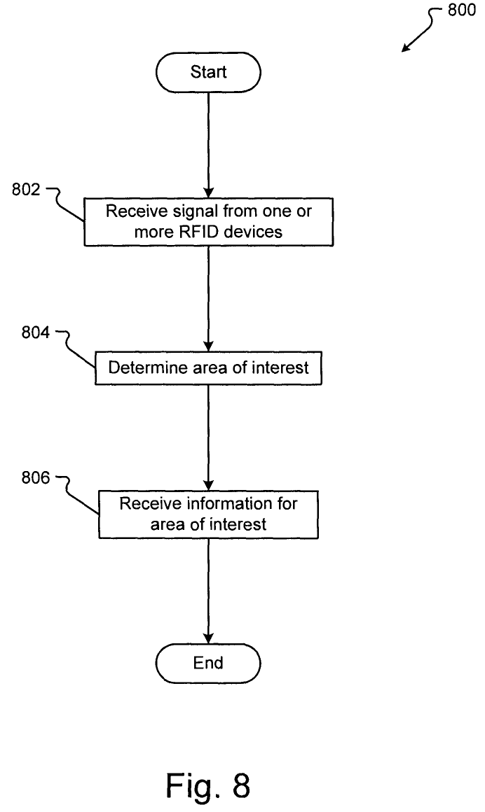

An embodiment of a method 800 for providing location-associated information is shown in FIG. 8. Receive operation 802 receives one or more signals from one or more RFID devices, such as RFID tag 110 (FIG. 1). In one embodiment, an active RFID reader, such as active RFID reader 612 (FIG. 6), receives RFID signals from the RFID tags. The RFID signals include location information. In one embodiment, the RFID signals designate an area of interest, a device identification that can be used to look-up and access information in a datastore, or a coordinate location and range that can be used to roughly triangulate position, as explained in conjunction with FIGS. 6 and 7.

Determine operation 804 determines a location. In one embodiment, an AOI determination component, such as AOI determination component 614 (FIG. 6), determines the area of interest in which a mobile device, such as mobile device 114 (FIG. 1), is located. In embodiments, an algorithm is executed to determine the most likely area of interest, as explained in conjunction with FIG. 6. In other embodiments, the coordinate location and range is used to roughly triangulate position, as explained in conjunction with FIG. 7. In one embodiment, the mobile device 114 (FIG. 1) sends the determined area of interest to an information server 118 (FIG. 1).

Receive operation 808 receives information associated with the area of interest. In embodiments, an information server 118 (FIG. 1) associates the area of interest with one or more items of information, such as advertising or other information, and sends the information to the mobile device 114 (FIG. 1). The mobile device receives the information and displays or provides the information to the customer, as explained in conjunction with FIG. 2.

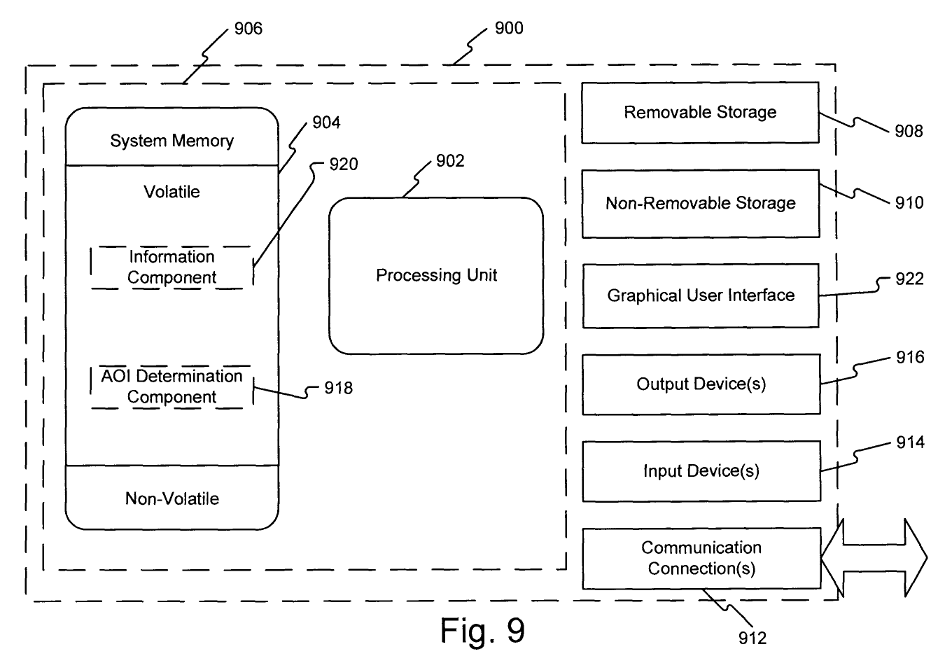

With reference to FIG. 9, an embodiment of a computing environment for implementing the embodiments described herein includes a computer system, such as computer system 900. The determination of the location of a customer and the provision of information and advertising based on the location may be executed in a client computer system, in a server computer system, in a combination of client and server computer systems, in a mobile device, and in other possible computing environments. As such, a basic computer system 900 applicable to all these environments is described hereinafter.

In its most basic configuration, computer system 900 typically includes at least one processing unit 902 and system memory 904. In embodiments, an area of interest (AOI) determination component 918 is loaded into and run by the processing unit 902 from system memory 904. In other embodiments, an information component 920 is loaded into and run by the processing unit 902 from system memory 904. Depending on the exact configuration and type of computer system 900, memory 904 may be volatile (such as RAM), non-volatile (such as ROM, flash memory, etc.), or some combination of the two. This most basic configuration of the computer system 900 is illustrated in FIG. 9 by dashed line 906.

Additionally, device 900 may also have additional features/functionality. For example, device 900 includes additional storage (removable and/or non-removable) including, but not limited to, magnetic, optical disks or tape. Such additional storage is illustrated in FIG. 9 by removable storage 908 and non-removable storage 910. In embodiments, an AOI determination component or information component is permanently stored in non-removable storage 910, although AOI determination component or information component may be saved into removable storage 908, and loaded into system memory 904 for execution by the processing unit 902. In some embodiments, the AOI determination component or information component is one or several components of another program. Computer storage media includes volatile and nonvolatile, removable and non-removable media implemented in any method or technology for storage of information such as computer readable instructions, data structures, program modules, or other data.

Memory 904, removable storage 908, and non-removable storage 910 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage, other magnetic storage devices, or any other medium which is used to store the desired information, such as AOI determination component or information component, and which is accessed by device 900 and processor 902. Any such computer storage media may be part of device 900.

Device 900 may also contain communications connection(s) 912 that allow the device to communicate with other devices. In embodiments, the communication connections 912 are used to determine an area of interest with an AOI determination component 918 executed on a mobile device that is in electrical communication with a network, such as an in-store wireless network, that sends the area of interest and other selected data to an information server, and that receives information or advertising from the information server. In still other embodiments, an AOI determination component 918 is loaded into system memory 904 or stored into removable storage 908 or non-removable storage 910 from a server accessed using the communication connections 912. In still further embodiments, the AOI determination component 918 and the information component 920 are both executed at a server and only advertising and information is sent to the mobile device.

Communications connection(s) 912 is an example of communication media. Communication media typically embodies computer readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media.

In embodiments, device 900 includes a graphical user interface 922 that may incorporate one or more input devices 914 or output devices 916, but one or more input devices 914 or output devices 916 may function separately from the graphical user interface 922. In one embodiment, RFID signals for an AOI determination component 918 are received with input device(s) 914, the area of interest is sent to a server, and the information or advertising associated with the area of interest is displayed with output device(s) 916 incorporated in the graphical user interface 922. Input device(s) 914 are also referred to as user interface selection devices and include, but are not limited to, a keyboard, a mouse, a pen, a voice input device, a touch input device, etc. Output device(s) 916 are also referred to as displays and include, but are not limited to, cathode ray tube displays, plasma screen displays, liquid crystal screen displays, speakers, printers, etc. These devices, either individually or in combination, may form the graphical user interface 922 used to display the information or advertising associated with an area of interest as described herein. All these devices are well know in the art and need not be discussed at length here.

Computer system 900 typically includes at least some form of computer readable media, which is some form of computer readable medium. Computer readable media can be any available media that can be accessed by processing unit 902. By way of example, and not limitation, computer readable media comprise computer storage media and communication media. AOI determination component 918 and information component 920 comprise such modules or instructions executable by computer system 900 that may be stored on computer storage medium and other tangible mediums and transmitted in communication media. Computer storage media includes volatile and nonvolatile, removable and non-removable media implemented in any method or technology for storage of information such as computer readable instructions, data structures, program modules, or other data. Combinations of the any of the above should also be included within the scope of computer readable media.

In some embodiments, computer system 900 is part of a network that stores data in remote storage media for use by the computing system 900. In embodiments, an AOI determination component 918 executing on a client system may access the remotely stored data to determine the area of interest. In other embodiments, the computing system 900 is a mobile device or similar computer that stores and operates the AOI determination component 918 on local client data stored in a local storage medium. In still other embodiments, the AOI determination component 918 is executed remotely on a server computer system, wherein the area of interest is determined remotely and information component 920 generates information associated with the area of interest that is returned to a client computer system.

Although the present invention has been described in language specific to structural features, methodological acts, and computer-readable media containing such acts, it is to be understood that the present invention defined in the appended claims is not necessarily limited to the specific structure, acts, or media described. One skilled in the art will recognize other embodiments or improvements that are within the scope and spirit of the present invention. Therefore, the specific structure, acts, or media are disclosed as exemplary embodiments of implementing the claimed invention. The invention is defined by the appended claims.

What is claimed is:

1. A system that provides information to a customer in a store, comprising:
one or more RFID devices, the RFID devices providing a signal;
a mobile device in electrical communication with the one or more RFID devices, the mobile device operable to receive the one or more RFID signals and determine an area of interest for the mobile device from the one or more RFID signals, and the mobile device operable to provide information about the mobile device and the area of interest; and
an information server in electrical communication with the mobile device, the information server operable to receive the information about the mobile device and the area of interest, the information server also operable to send, to the mobile device, information associated with the area of interest.

2. A system as defined in claim 1, wherein one RFID device is an active RFID tag.

3. A system as defined in claim 1, wherein the mobile device is operable to present the information associated with the area of interest to the customer.

4. A system as defined in claim 1, wherein the information associated with the area of interest includes advertising or product information for a product in the area of interest.

5. A system as defined in claim 1, wherein the mobile device is operable to determine that the mobile device is in two or more nested areas of interest.

6. A system as defined in claim 1, wherein the information server accesses a remote resource to obtain a portion of the information about the area of interest.

7. A system as defined in claim 1, wherein the information server comprises:
a communication component in electrical communication with the mobile device, the communication component operable to receive the information about the mobile device and the area of interest from the mobile device, and the communication component operable to send information associated with the area of interest to the mobile device; and
an information component coupled to the communication component, the information component operable to receive the information about the mobile device and the area of interest from the communication component, the information component operable to obtain the information associated with the area of interest, and the information component operable to send the information associated with the area of interest to the communication component.

8. A system as defined in claim 7, wherein the information component accesses a product information database to obtain the information associated with the area of interest.

9. A method, executable in a computer system, for providing product information, on a mobile device, to a customer in a store, the method comprising the steps of:
receiving, at a mobile device, location information from one or more active RFID tags in an area of interest;
determining the area of interest from the location information;
sending the area of interest and information about the mobile device to an information server;
receiving product information for a product in the area of interest; and
providing the product information to the customer.

10. A method as defined in claim 9, wherein the location information is a designation of an area of interest in which the active RFID tag is located.

11. A method as defined in claim 9, wherein the location information is a RFID tag identification and the method further comprises:
associating the one or more RFID tag identifications to one or more areas of interest; and
determining from the one or more areas of interest a most likely area of interest.

12. A method as defined in claim 11, wherein determining from the one or more areas of interest a most likely area of interest comprises:
calculating a ratio between a first area of interest and the total number of areas of interest;
comparing the ratio to a predetermined threshold; and
if the ratio is greater than the predetermined threshold, designating the first area of interest as the most likely area of interest.

13. A method as defined in claim 12, wherein the one or more areas of interest include one or more nested areas of interest in two or more levels and a most likely area of interest is designated for each level.

14. A method as defined in claim 11, wherein determining from the one or more areas of interest a most likely area of interest, comprises:
calculating a first ratio between a first area of interest and the total number of areas of interest;
calculating a second ratio between a second area of interest and the total number of areas of interest;
comparing the first ratio to the second ratio; and
if the first ratio is greater than the second ratio, designating the first area of interest as the most likely area of interest.

15. A method as defined in claim 14, further comprising:
if the first ratio and the second ratio are equal, accessing temporal location information for the mobile device;
determining if the first area of interest was designated the most likely area of interest previously; and
if the first area of interest was not designated the most likely area of interest previously, designating the first area of interest as the most likely area of interest.

16. A method as defined in claim 9, wherein the location information includes a coordinate location and a range for the one or more active RFID tags, and wherein determining the area of interest from the location information comprises determining a rough triangulation between the coordinate location and the range of the one or more active RFID tags.

17. A computer readable medium including at least one tangible medium, executable on a computing system that is in electrical communication with an RFID reader, which is operable to receive location information from an RFID device, the computer readable medium encoding computer program components for providing information about a product to a customer in a store, the components comprising:
an area of interest determination component coupled to the RFID reader, the area of interest determination component operable to determine an area of interest for which the mobile device is located, the area of interest associated with the location information received by the RFID reader; and
a communication component coupled to the area of interest determination component, the communication component operable to send the area of interest to an information server, and the communication component operable to receive information about the area of interest from the information server.

18. A computer readable medium as defined in claim 17, further comprising a display component coupled to the communication component, the display component operable to present the information about the area of interest to a customer.

19. A computer readable medium as defined in claim 17, wherein the computing system is also in electrical communication with a passive RFID tag reader coupled to the communication component, the passive RFID reader operable to receive information about an item of interest and send the information about the item of interest to the communications component.

20. A computer readable medium as defined in claim 19, wherein the communication component is also operable to send the information about the item of interest to the information server and receive item information from the information server.
